(19) United States
(12) Patent Application Publication
(10) Pub. No.: US 2025/0210878 A1
(43) Pub. Date: Jun. 26, 2025

(54) DEPLOYABLE PETALLED REFLECTOR AND METHODS OF ASSEMBLING AND DEPLOYING A PETALLED REFLECTOR

(71) Applicant: MacDonald, Dettwiler and Associates Corporation, Sainte-Anne-de-Bellevue (CA)

(72) Inventors: Giuseppe Mennitto, Montreal (CA); François Lanciault, Blainville (CA); Gérard Sénéchal, Ste-Anne-de-Bellevue (CA); Frederic Lanoue, Saint-Laurent (CA); Eric Dubreuil, Pierrefonds (CA)

(21) Appl. No.: 18/965,628

(22) Filed: Dec. 2, 2024

Related U.S. Application Data
(60) Provisional application No. 63/612,424, filed on Dec. 20, 2023.

(51) Int. Cl. H01Q 15/14

(52) U.S. Cl. CPC H01Q 15/147

(57) ABSTRACT

An antenna reflector and methods for stowing and deploying are provided. The reflector includes a hexagonal central portion and six trapezoidal petals, each two opposing petals forming a petal pair. Each petal includes a first edge equal in length to a central edge, a second edge greater in length than and parallel to the first edge, and third and fourth edges connecting the first and second edges. In a stowed configuration, each petal pair is folded and has a cross-sectional footprint substantially identical to that of the central reflecting portion. In a deployed configuration, each petal is not folded, and the petals and the central reflecting portion together form a hexagon with a cross-sectional footprint larger than that of the central reflecting portion. Each petal is configured to fold and unfold along the first edge from the deployed configuration to the stowed configuration and vice-versa.

### TECHNICAL FIELD

The following relates generally to antenna reflectors, and more particularly to deployable antenna reflectors.

### INTRODUCTION

In the field of reflectors, “lower-priced” solid-shell reflectors with diameter 3 m or greater that may be accommodated on especially small spacecrafts have yet to be developed. Current large deployable reflectors are of a mesh type, which are expensive and packaged to fit on large spacecrafts. Moreover, mesh-type reflector surfaces are not able to be shaped or customized, limiting their use as anything other than a parabolic reflector.

Solid-shell deployable surface reflectors with diameter 3 m or greater may be a less expensive option, for example 3 to 4 times less expensive than a large deployable mesh-surface reflector. Such solid-shell reflectors further advantageously reflect signals in the Ka/Ku/C/S/L bands, whereas mesh reflectors may only reflect signals in the Ku/C/S/L bands. Furthermore, solid-shell reflectors advantageously have little to no undesirable passive intermodulation (PIM), whereas mesh reflectors, by their nature, always suffer from some PIM.

Accordingly, there is a need for an improved system and method for deploying large solid-shell reflectors on spacecraft that overcomes at least some of the disadvantages of existing systems and methods.

### SUMMARY

An antenna reflector for reflecting a radio frequency (RF) signal is provided, the antenna reflector for fitting into a smaller footprint when stowed than when deployed, the antenna reflector including a hexagonal central reflecting portion having a first face and an opposed second face, the first face for reflecting the RF signal, and six central edges of equal length and six trapezoidal petals disposed about the hexagonal central reflecting portion and having first faces and opposed second faces, the first faces for reflecting the RF signal, each two opposing petals forming a petal pair, each petal including a first edge equal in length to a respective central edge, each first edge disposed adjacent to the respective central edge, a second edge greater in length than the first edge and parallel to the first edge, third and fourth edges connecting the first and second edges. In a stowed configuration each petal pair is folded and has a cross-sectional footprint substantially identical to a cross-sectional footprint of the central reflecting portion, and each of the second edges of each petal pair are mutually adjacent. In a deployed configuration each petal is not folded, the petals and the central reflecting portion together form a hexagon with a cross-sectional footprint larger than the cross-sectional footprint of the central reflecting portion, each third edge of each petal is disposed adjacent a respective fourth edge of an adjacent petal, and each fourth edge of each petal is disposed adjacent a respective third edge of an adjacent petal. Each petal is configured to fold along the first edge from the deployed configuration to the stowed configuration and each petal is configured to unfold along the first edge from the stowed configuration to the deployed configuration.

The antenna reflector may further include a boom connected to the second face of the central reflecting portion for actuating the antenna reflector. The boom may flip the antenna reflector at least once when the petals fold from the deployed configuration to the stowed configuration or when the petals unfold from the stowed configuration to the deployed configuration, to avoid interference with the boom.

The petals and the central reflecting portion may be curved.

The petals and the central reflecting portion may be flat.

The antenna reflector may further include three primary release mechanisms, each primary release mechanism for releasably fastening at least some of the petals to the central reflecting portion.

The antenna reflector may further include six folding mechanisms, each folding mechanism disposed about a respective first edge of a respective petal for selectively allowing or disallowing the respective petal to fold or unfold.

The primary release mechanisms may be tie-downs and the folding mechanisms may be hinges.

At least one petal pair may be configured to fold towards the first face of the central reflecting portion and at least one other petal pair may be configured to fold towards the second face of the central reflecting portion.

All petal pairs may be configured to fold towards the same face of the central reflecting portion.

A method for deploying a petalled reflector for reflecting an RF signal is provided, the petalled reflector for fitting into a smaller footprint when stowed than when deployed, the method including providing the petalled reflector in a stowed configuration, the petalled reflector comprising a hexagonal central reflecting portion having a first face and an opposed second face, the first face for reflecting the RF signal, and six central edges of equal length, and six trapezoidal petals disposed about the hexagonal central reflecting portion and having first faces and opposed second faces, the first faces for reflecting the RF signal, each two opposing petals forming a petal pair, each petal including a first edge equal in length to a respective central edge, each first edge disposed adjacent a respective central edge, a second edge greater in length than the first edge and parallel to the first edge, and third and fourth edges connecting the first and second edges. In the stowed configuration each petal pair is folded and has a cross-sectional footprint substantially identical to a cross-sectional footprint of the central reflecting portion, and each of the second edges of each petal pair are mutually adjacent. The method further includes unfolding each pair of petals along the first edge, disposing each third edge of each petal adjacent a respective fourth edge of an adjacent petal and disposing each fourth edge of each petal adjacent a respective third edge of an adjacent petal. The petals and the central reflecting portion together form a hexagon with a cross-sectional footprint larger than the cross-sectional footprint of the central reflecting portion.

The method may further include actuating the petalled reflector with a boom connected to the second face of the central reflecting portion and flipping the petalled reflector at least once to avoid interference with the boom.

The petals and the central reflecting portion may be curved.

The petals and the central reflecting portion may be flat.

The method may further include releasably fastening at least some of the petals to the central reflecting portion with each of three primary release mechanisms.

The method may further include selectively allowing or disallowing a respective petal to unfold using each of six folding mechanisms, each folding mechanism disposed about the respective first edge.

The primary release mechanisms may be tie-downs and the folding mechanisms may be hinges.

At least one petal pair may be folded towards the first face of the central reflecting portion and at least one other petal pair may be folded towards the second face of the central reflecting portion.

All petal pairs may be folded towards the same face of the central reflecting portion.

A method for stowing a petalled reflector for reflecting an RF signal is provided, the petalled reflector for fitting into a smaller footprint when stowed than when deployed, the method including providing the petalled reflector in a deployed configuration, the petalled reflector including a hexagonal central reflecting portion having a first face and an opposed second face, the first face for reflecting the RF signal, and six central edges of equal length, and six trapezoidal petals disposed about the hexagonal central reflecting portion and having first faces and opposed second faces, the first faces for reflecting the RF signal, each two opposing petals forming a petal pair, each petal including a first edge equal in length to a respective central edge, each first edge disposed adjacent a respective central edge, a second edge greater in length than the first edge and parallel to the first edge, and third and fourth edges connecting the first and second edges. In the deployed configuration each third edge of each petal is disposed adjacent a respective fourth edge of an adjacent petal and each fourth edge of each petal is disposed adjacent a respective third edge of an adjacent petal. The petals and the central reflecting portion together form a hexagon with a cross-sectional footprint larger than that of the central reflecting portion. The method further includes folding each pair of petals along the first edge. Each petal pair when folded has a cross-sectional footprint substantially identical to a cross-sectional footprint of the central reflecting portion. Each of the second edges of each petal pair are mutually adjacent when folded.

The method may further include actuating the petalled reflector with a boom connected to the second face of the central reflecting portion and flipping the petalled reflector at least once to avoid interference with the boom.

The petals and the central reflecting portion may be curved.

The petals and the central reflecting portion may be flat.

The method may further include releasably fastening at least some of the petals to the central reflecting portion with each of three primary release mechanisms.

The method may further include selectively allowing or disallowing a respective petal to fold using each of six folding mechanisms, each folding mechanism disposed about the respective first edge.

The primary release mechanisms may be tie-downs and the folding mechanisms may be hinges.

The method may further include folding at least one petal pair towards the first face of the central reflecting portion and folding at least one other petal pair towards the second face of the central reflecting portion.

The method may further include folding all petals pairs towards the same face of the central reflecting portion.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a perspective view of a petalled reflector assembly in a deployed configuration, according to an embodiment;

FIG. 1B is a perspective view of the central reflecting portion and a single petal of the petalled reflector of FIG. 1A in isolation;

FIG. 1C is a perspective view of the petalled reflector assembly of FIG. 1A in which the boom and the petalled reflector are fully stowed;

FIG. 1D is a perspective view of the petalled reflector assembly of FIG. 1A in a stowed configuration, according to an embodiment;

FIG. 2A is a perspective view of the petalled reflector assembly of FIG. 1A in the stowed configuration within a reflector stowed stay-in envelope, according to an embodiment;

FIG. 2B is a top view of the petalled reflector assembly of FIG. 2A;

FIG. 2C is a side view of the petalled reflector assembly of FIG. 2A;

FIG. 2D is a front view of the petalled reflector assembly of FIG. 2A;

FIGS. 3A-31 are perspective views of the petalled reflector assembly of FIGS. 1A-1D being deployed from a stowed configuration to a deployed configuration, according to an embodiment;

FIG. 4A is a front perspective view of a petalled reflector assembly in a deployed configuration, according to an embodiment;

FIG. 4B is a rear perspective view of the petalled reflector assembly of FIG. 4A, according to an embodiment; and

FIG. 5 is a flowchart of a method of deploying a petalled reflector assembly, according to an embodiment;

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to deployable antenna reflectors, and more particularly to deploying large solid-shell reflectors on spacecraft.

In particular, the present disclosure provides a deployable petalled solid-shell reflector where the petals are stored as stacks atop and/or below a central reflecting portion to minimize a launch stay-in volume of the reflector when stowed.

Solid-shell reflectors present numerous advantages over mesh reflectors, such as lower cost, efficient reflection in the Ka band, non-parabolic shaping, and less to no undesirable PIM. The single-piece nature of typical solid-shell reflectors ordinarily means that there is no way to effectively stow such solid-shell reflectors to minimize the launch stay-in volume thereof has been available, and the foregoing advantages of solid-shell reflectors have not been realized. The present disclosure provides a deployable, petalled solid-shell reflector that may advantageously realize the foregoing advantages.

The present disclosure describes a preferred embodiment. In other embodiments, petals may be of any even or odd number, may be paired or not, may be stowed on either side of the central reflecting portion or both, and may form any external perimeter shape upon deployment (e.g., hexagon, circle, ellipse, super-ellipse).

In an embodiment, the petalled reflector includes an RF surface divided into seven sections: an internal hexagon and six external petals. The hexagon and/or petals may be composite solid sandwich. Where the hexagon and/or petals are composite solid sandwich constructions, such constructions may include CFRP skins or aluminum skins and a different core material type. Each petal is stowed with respect to the hexagon via a single axis. Each axis is parallel to a hexagon edge. Each axis is located behind the RF surface. Each petal folds away from the RF surface and is stowed behind the hexagon. The resulting geometry may provide for a simple hinge design (folding mechanism) with all hardware located behind the RF surface. The reflector configuration and geometry may provide PIM free operation with RF losses limited to gaps between adjacent sections and tie-down holes. The internal hexagon may be fixed to a common flat panel. The petals may be each fixed to the internal hexagon or common flat panel via two hinges (folding mechanism). The petals fold relative to the internal hexagon via action of the hinges.

In an embodiment, the hexagon and/or petals are laminate constructions. In an embodiment, the hexagon and/or petals are machined aluminum constructions. In an embodiment, the hexagon and/or petals are provided from a combination of laminate constructions and machined aluminum constructions.

The present disclosure provides a large antenna reflector that fits into a much smaller footprint when in the stowed configuration than in the deployed configuration.

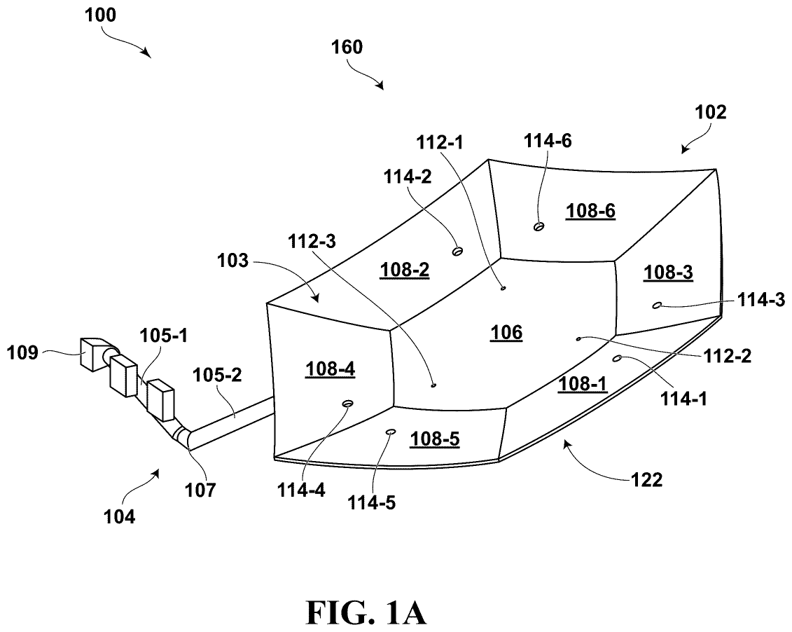

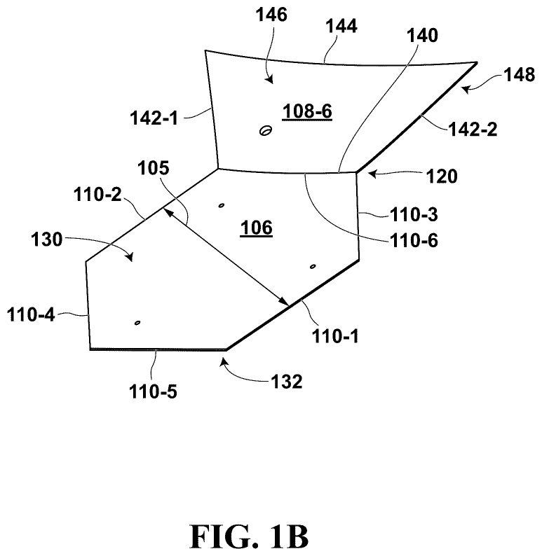

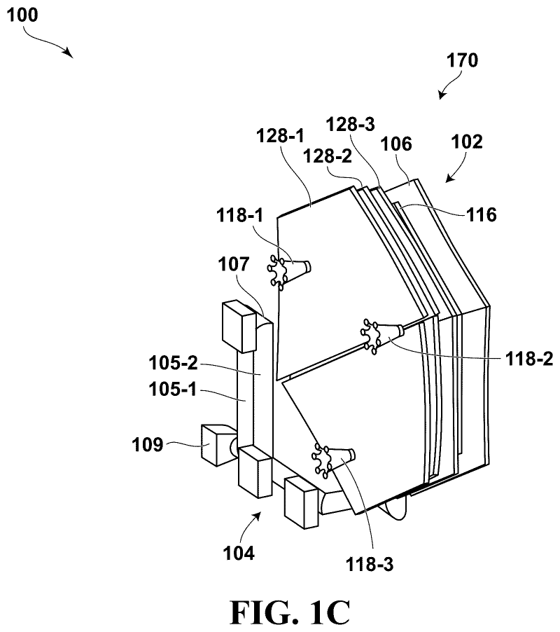

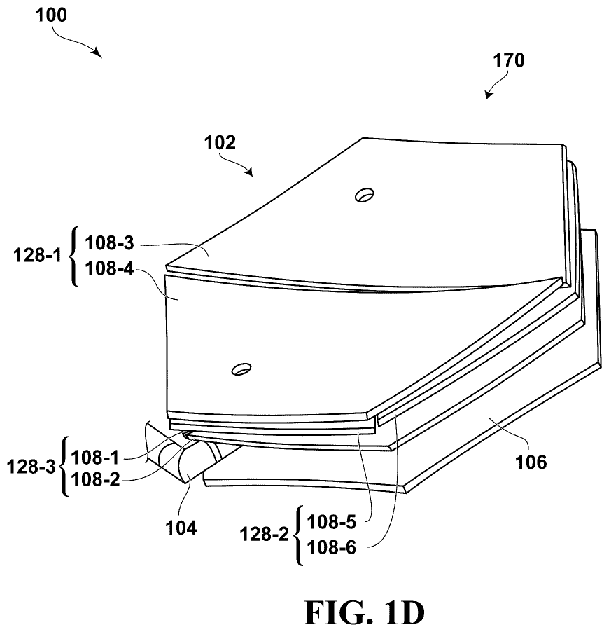

Referring now to FIGS. 1A-1D, shown therein is a petalled reflector assembly 100, according to an embodiment.

FIG. 1A shows the reflector assembly 100 in a deployed configuration 160. FIG. 1B shows a central reflecting portion and a petal of the reflector assembly 100 from FIG. 1A in isolation. FIG. 1C shows the reflector assembly 100 in a stowed configuration 170. FIG. 1D shows the reflector assembly 100 in the stowed configuration 170 at a different angle.

The petalled reflector assembly 100 in the stowed configuration 170 may be stowed or stored on or inside a spacecraft, a bay thereof, or otherwise provided on or within a vehicle configured to launch or having launched into space (not shown). Simultaneous reference may be made to each of FIGS. 1A-1D herein.

The petalled reflector assembly 100 is part of a larger antenna system. The petalled reflector assembly 100 is implemented on an antenna platform. In an embodiment, the antenna platform is a spacecraft, such as a satellite bus.

Referring first to FIG. 1A, the petalled reflector assembly 100 includes a petalled reflector 102 and a boom 104 connected to the petalled reflector 102.

The boom 104 is configured to move or manipulate the petalled reflector 102 between two or more positions. The boom 104 connects the petalled reflector 102 to a spacecraft or other antenna platform. This connection is not shown in FIGS. 1A-1D. The boom 104 actuates the petalled reflector 102. This may include actuating the reflector 102 between a stowing location and a deployment location. The boom 104 may actuate the petalled reflector 102 in the deployed configuration 160 into multiple reflector positions.

The petalled reflector 102 is configured to reflect RF signals. The petalled reflector 102 includes an RF reflecting surface 103 for reflecting the RF signals. The reflecting surface 103 is sectioned in a petalled design, as will be further explained herein. The petalled reflector 102 is deployable, as will be further explained herein.

The petalled reflector 102 includes a central reflecting portion 106 and a plurality of reflecting petals 108-1, 108-2, 108-3, 108-4, 108-5, and 108-6. The petals 108-1, 108-2, 108-3, 108-4, 108-5, and 108-6 are referred to collectively as petals 108 and generically as petal 108. In an embodiment, the central reflecting portion 106 and the petals 108 are configured as composite solid sandwich constructions.

The central reflecting portion 106 and petals 108 are physically distinct or separate pieces or sections of the reflector 102. The central reflecting portion 106 and the petals 108 together form the RF reflective surface 103 of the reflector 102. The central reflecting portion 106 and the petals 108 may be flat or curved (as in a parabolic reflector). The central reflecting portion 106 and the petals 108 may be composed of any suitable material for providing the structural stability and RF reflective properties to the reflector 102. For example, the central reflecting portion 106 and the petals 108 may be composed of graphite or aluminum.

The petalled reflector 102 is advantageously a solid-shell reflector that can be stowed as shown in FIG. 1C. The solid-shell petalled reflector 102 is adaptable to shaping in order to provide precise coverage (receive and transmit signals) of specific areas on the Earth and/or maximize RF performance. Such shaping functionality is possible because the reflective surface 103 in the deployed configuration 160 is advantageously continuous and shapeable (i.e. includes concave and convex forms). The petalled reflector 102 may also be a simple parabolic reflector (i.e. concave form only). The petalled reflector 102 may be partially parabolic and partially shaped (e.g., some portions parabolic and some portions shaped).

In an embodiment, in the deployed configuration 160, each petal 108 and the central reflecting portion 106 are reflective, i.e., contribute to the reflective surface 103.

Referring now to FIG. 1B, further features of the central reflecting portion 106 and petal 108-6 are identified. Petal 108-6 is used as a representative petal for showing petal features and it should be understood that the other petals 108 have the same features.

Central reflecting portion 106 is hexagonal, having six outer sides or edges 110-1, 110-2, 110-3, 110-4, 110-5, and 110-6 (collectively referred to as edges 110 or central edges 110 and generically referred to as edge 110 or central edge 110). Each edge 110 has a corresponding opposite edge. As an example, edges 110-1, 110-2 are opposite one another, illustrated by arrow 105, and thus opposite edges.

The edges 110 may be equal in length. In other embodiments, the central reflector portion 106 may be another polygon with an even or odd number of sides, such as a triangle, square or octagon. In such other embodiments, the number of petals 108 equals the number of sides of the central reflecting portion 106. In other embodiments, some or all of the petals need not be stowed/deployed in pairs.

In the embodiment of FIGS. 1A-1D, where the central reflecting portion 106 is hexagonal and each petal 108 is trapezoidal, the outer perimeter of the reflector 102 is hexagonal in both the deployed configuration 160 and the stowed configuration 170.

The central reflecting portion 106 includes a first side 130 and a second side 132. The first and second sides 130, 132 are opposite one another (e.g., first side 130 may be considered a top side and second side 132 considered a bottom side). Second side 132 is not visible in FIG. 1B due to the view angle. The first side 130 is for reflecting RF signals and forms part of the reflecting surface 103 of the reflector 102. The second side 132 may be used for mounting or connecting one or more components to the central reflecting portion 106.

Petal 108-6 includes a bottom edge 140, side edges 142-1 and 142-2, and top edge 144. Bottom edge 140 and top edge 144 are generally parallel to one another. In some embodiments, top edge 144 may not be straight. In some embodiments, top edge 144 may be arcuate or of another profile. Bottom edge 144 may be considered and referred to as folding edge 144, as it is the edge of the petal 108 along which the petal folds relative to the central portion 106 when deploying or stowing.

Petal 108-6 has a first side 146 and a second side 148 opposite the first side 146. The first side 146 is for reflecting RF signals and further forms part of the reflecting surface 103 of the reflector 102. The second side 148 may be used to mount the petal 108-6 (e.g., directly or indirectly to the central portion 106).

Petal bottom edge 140 is generally the same length as edge 110-6 of the central reflecting portion 106. Petal bottom edge 140 and central portion edge 110-6 are considered a shared or common edge between the petal 108-6 and the central portion 106. Petal bottom edge 140 and central portion edge 110-6 generally about one another when in the deployed configuration 160.

In the deployed configuration 160, each side edge 142-1 of each petal 108 is disposed adjacent a respective side edge 142-2 of an adjacent petal 108, and each side edge 142-2 of each petal 108 is disposed adjacent a respective side edge 142-1 of an adjacent petal 108. The petals 108 may be sized, shaped, and configured to minimize gaps between adjacent petals and between the petals and the central portion 106.

Petal 108-6 may be connected to the central portion 106 directly, such as by an element connecting side 148 to side 132, or indirectly through a support panel (e.g., support panel 116, visible in FIG. 1C). In the case of a support panel, the petal 108-6 and the central portion 106 are each connected to the support panel. Unless otherwise stated, reference made to the petals 108 being connected to the central portion 106 are understood to include a direct connection to the central portion 106 or indirect connection through a support panel.

Petal 108-6 is configured to fold or rotate along an axis parallel to folding edge 140 in both directions to enable movement of the petal between the deployed configuration 160 and the stowed configuration 170. Each of the folding edge 140 and the central edge 110-6 may be considered to be parallel to or define an axis of rotation for the respective petal 108-6. The axis of rotation may further be defined by two spherical bearings (not shown) to reduce alignment requirements during assembly, to render the respective petal 108-6 self-aligning, and/or to prevent binding during deployment of the petalled reflector 102. For example, if two hinges on a shared edge are not perfectly aligned, as the petal 108 rotates, there may be some resistance or binding. Having at least one of the two hinges as a swivel bearing eliminates the risk of binding.

Each petal 108 is configured to fold or rotate along folding edge 140 via a respective folding mechanism 120 (the folding mechanism 120 of petal 108-6 is indicated in FIG. 1B). The reflector assembly 100 includes a folding mechanism 120 for each petal 108 in the reflector 102 that is dedicated to moving that petal 108. The folding mechanism 120 is configured to move the petal 108 from the stowed configuration 170 to the deployed configuration 160. In some embodiments, the folding mechanism 120 is configured to also move the petal 108 from the deployed configuration 160 to the stowed configuration 170. In general, the folding mechanism 120 may be any mechanism suitable for moving the petals 108 at least from the stowed configuration 170 to the deployed configuration.

The folding mechanism 120 may be a passive mechanism or an active mechanism. In the case of a passive folding mechanism 120, the reflector assembly 100 may further include one or more petal hold and release mechanisms for holding the petals 108 in the stowed configuration 170 and, once released, the folding mechanism 120 passively deploys the petal 108. In other words, the passive folding mechanism 120 may automatically cause the petal 108 to deploy unless otherwise constrained (e.g., by a hold and release mechanism).

In an embodiment, the folding mechanism 120 is a hinge mechanism configured to allow a limited angle of rotation of the petals 108 relative to the central reflecting portion 106. In an embodiment, the hinge mechanism includes two spring-loaded hinges with passive dampers. Where the folding mechanism 120 is a passive mechanism, the folding mechanism 120 may include a shape memory alloy mechanism or a compliant mechanism. Where the folding mechanism 120 is an active mechanism, the folding mechanism 120 may be a motor, high output paraffin thermal actuator, or other kind of powered actuator.

In an embodiment, each folding mechanism 120 deploys in a predetermined sequence. The predetermined sequencing may be controlled by a controller of the folding mechanisms 120 or by the sequenced release of hold and release mechanisms on the reflector 102.

Referring now to FIG. 1C, the reflector assembly 100 further includes support panel 116. The support panel 116 is mounted to the second side 132 of the central reflecting portion 106. The support panel 116 may be centrally mounted on the central reflecting portion 106. The support panel 116 may be flat. The support panel 116 is hexagonal like the central reflecting portion 106. In other embodiments, the support panel 116 may have any other suitable shape. In some embodiments, the shape of the support panel 116 is the same as the shape of the central reflecting portion 106. The support panel 116 may be sized to be smaller than the central reflecting portion 106.

The support panel 116 may be a composite solid sandwich construction. The support panel 116 includes an interface with the boom 104. The boom 104 may connect to the support panel 116 on its edge, or single or both sides. The boom 104 actuates the petalled reflector 102 by actuating the support panel 116 connected thereto. The support panel 116 may act as a common support structure for the central reflecting portion 106, the petals 108, and tie-down and boom interfaces. In an embodiment, the central reflecting portion 106 is fixed to the support panel 116 and the petals are fixed to the support panel via the folding mechanism 120 (e.g., two hinges).

The folding mechanisms 120 may connect to the support panel 116 at one end (e.g., near its periphery) and to the second side 148 of the petal 108 at the other end (e.g., near folding edge 140).

In some embodiments, the reflector assembly 100 may not include a support panel 116. In such cases, the features provided at the support panel 116 may be provided by or implemented on the central reflecting portion 106.

Referring now to FIG. 1D, the petals 108 are configured in a plurality of petal pairs 128-1, 128-2, 128-3, each pair including two petals 108. Petal pair 128-1 includes petals 108-3 and 108-4, petal pair 128-2 includes petals 108-1 and 108-2, and petal pair 128-3 includes petals 108-5 and 108-6. Petal pairs are referred to collectively as petal pairs 128 and generically as petal pair 128.

Petal pairs 128 are formed by those petals 108 whose respective folding edges 140 about opposite edges 110 of the central reflecting portion 106. In the stowed configuration 170, an axis (not shown) is formed between the petals 108 in each pair 128, each axis being further defined by opposing vertices of the hexagonal stack 128.

Petals 108 in a petal pair 128 may be configured to deploy (and, in some cases, stow) simultaneously or sequentially. Petal pairs 128 are configured to deploy (and stow) sequentially.

When going from the deployed configuration 160 to the stowed configuration 170, petals 108 in a petal pair 128 are configured to fold along or rotate about their respective folding edge 140 to a point at which the top edges 144 of the petals 108 are disposed next to one another (face each other). An example of such a configuration can be seen in FIG. 1D in which top edges 144 of petals 108-4 and 108-3 of petal pair 128-1 are neighbouring edges when the reflector 102 is in the stowed configuration 170.

In the particular embodiment of FIGS. 1A-1D, this positioning of petal pairs 128 in the stowed configuration 170 may enable the petals to be contained entirely within the cross-sectional footprint (or nearly entirely within) of the central reflecting portion 106. Such configuration may provide the advantage of minimizing the footprint occupied by the reflector 106 when in the stowed configuration 170. In other words, each petal pair 128 when stowed may have a substantially similar cross-sectional area to that of the central reflecting portion 106.

In this way, a petal pair 128 in the stowed configuration 170 may be considered to form a petal stack or stack, and such term may be used interchangeably with petal pair 128 herein. The term stack refers to the fact that the petal pairs 128 and the central reflecting portion 106 for a stack when in the stowed configuration 160.

In the embodiment of FIG. 1D, all three petal pairs 128-1, 128-2, 128-3 are stowed/stacked on one side (second side 132) of the central reflecting portion 106. In other embodiments, petal pairs 128 may be stacked entirely on the other side (e.g., first side 130) of the central reflecting portion 106 or the petal pairs 128 may be stacked such that one or more petal pairs 128 are stacked on each side of the central reflecting portion 106 (i.e., to have petal pairs stowed on each side of the central portion 106).

Stowing petal stacks 128 on both sides 130, 132 of the central reflecting portion 106 may advantageously minimize the size of some of the folding mechanisms 120. For example, in the case of a hinge mechanism, hinge size may be reduced by not stacking all petal pairs 128 on one side of the central reflecting portion 106.

As previously noted, although FIGS. 1A, 1B show a hexagonal central reflecting portion 106, hexagonal stacks 128, and trapezoidal petals 108, each pair of trapezoidal petals 108 together form each hexagonal stack 128, it will be appreciated by one of skill in the art that the foregoing elements may take or include different geometric shapes suitable for the purpose of the present disclosure. For example, the central reflecting portion 106 may be substantially square or square-like in shape, with each stack 128 similarly substantially rectangular or rectangular-like in shape, and each petal 108 substantially rectangular or rectangular-like in shape in order to achieve the objects of the present disclosure. In a further example, the central reflecting portion 106 may be substantially octagonal or octagon-like in shape, and each petal 108 in the shape of an irregular polygon approximately equal in area to half an octagon in order to achieve the objects of the present disclosure. In a further example, the central reflecting portion 106 may be substantially decagonal or decagon-like in shape, and each petal 108 in the shape of an irregular polygon approximately equal in area to half a decagon in order to achieve the objects of the present disclosure.

Preferably the central reflecting portion 106 takes or includes a geometric shape with an even number of edges and vertices such that the petalled reflector 102 includes an even number of petals 108 so that each stack 128 includes exactly two petals 108 that substantially cover one side of the central reflecting portion 106 when the petalled reflector 102 is in the stowed configuration 170.

More preferably the central reflecting portion 106 takes or includes a geometric shape with an even number of edges and vertices exactly twice an odd number such that the side or edge with the greatest length among the sides or edges of each petal 108 is parallel to exactly one other side or edge of the respective petal 108 that abuts a side or edge 110 of the central reflecting portion 106. This embodiment does not preclude embodiments that include a central reflecting portion with an odd number of sides and an odd number of petals that are not paired and further are not stowed and deployed as pairs.

A hexagonally-shaped central reflecting portion 106 advantageously achieves the foregoing objective particularly well because each of the petals 108 may be trapezoidal as depicted in the figures. Accordingly, the lengthiest edges 144 of each petal may together form the perimeter of a larger hexagon embodying the reflector 102. Moreover, each of the other two sides 142-1, 142-2 of each petal 108 overlaps or abuts with one of the other two sides 142-2, 142-1 of each respective adjacent petal 108. Accordingly, a reflector 102 that includes a hexagonally-shaped central reflecting portion 106 and trapezoidal petals 108 may advantageously be self-similar when deployed (forming a larger hexagon) and stowed (forming a smaller hexagon). Such self-similarity may advantageously simplify calculations with respect to positioning, movement, storage, etc. of the reflector 102 and may further improve reflection thereby. A further advantage of the foregoing self-similarity is that the stowed reflector 102 maintains a self-similar, hexagonal cross-sectional footprint when stowed, that is, the stowed reflector 102 takes up no greater surface area (e.g., within a reflector stowed stay-in envelope) than the surface area of the central reflecting portion 106. A further advantage of the hexagonally-shaped central reflecting portion 102 is increased structural efficiency associated with having 3 or 6 spacecraft tie-downs 118 with respect to a hexagon footprint on the spacecraft.

Referring again to FIG. 1C, the reflector assembly 100 further includes a plurality of spacecraft tie-down release mechanisms 118-1, 118-2, 118-3 (referred to collectively as spacecraft tie-down release mechanisms 118 and generically as spacecraft tie-down release mechanism 118).

The spacecraft tie-down release mechanisms 118 constrain the stowed reflector 102 at launch (by coupling the reflector 102 to the spacecraft). Each spacecraft tie-down release mechanism 118 interfaces to the support panel 116 and multiple petals 108. This may be done via stacked cup-cone metallic parts. Release of the spacecraft tie-down release mechanisms 118 release the reflector 102 from the spacecraft. Spacecraft tie-down release mechanisms 118 may also be referred to as primary release mechanisms when reflector assembly 100 also includes petal release mechanisms (as described herein). In an embodiment, spacecraft release mechanism 118 is a single use or one-time release mechanism, such as a Frangibolt, separation nut, or the like.

While reflector assembly 100 includes three spacecraft tie-down release mechanisms 118, in other embodiments, the number of spacecraft tie-down release mechanisms may vary and is not particularly limited. For example, an embodiment with a 3 m or smaller diameter reflector may use three spacecraft tie-down release mechanisms 118, while a reflector with a diameter larger than 3 m may use six spacecraft tie-down release mechanisms 118.

Release of the spacecraft tie-down release mechanisms 118 may be sequential or simultaneous.

Reflector 102 includes holes 114-1, 114-2, 114-3, 114-4, 114-5, 114-6 in petals 108 (one in each petal) and holes 112-1, 112-2, 112-3 in central reflecting portion 106 for accommodating the spacecraft release mechanisms 118. The number of holes may vary depending on the number of release mechanisms 118 used. Holes 114 and 112 are positioned such that they align when the reflector 102 is in the stowed configuration 170, thereby allowing the release mechanisms to pass through the stacked reflector.

The reflector assembly 100 further includes a plurality of petal release mechanisms (not shown). The petal release mechanisms are configured to fix each petal 108 to its opposite paired petal 108 (i.e., the two petals in a given petal pair) in the stowed configuration. Accordingly, in an embodiment, the number of petal release mechanisms is at least equal to the number of petal pairs 128, with one petal release mechanism dedicated to one petal pair 128. In some embodiments, the number of petal release mechanisms may be higher (e.g., two per petal pair, etc.).

In an embodiment, the petal release mechanism is a single use or one-time release mechanism, such as a separation nut, Frangibolt, or the like.

Petal release mechanisms may also be referred to as secondary release mechanisms when the reflector assembly 100 also includes spacecraft tie-down release mechanisms 118.

Release of the petal mechanisms are sequenced or sequential, in that the one or more petal release mechanisms holding a first-to-be deployed petal pair 128 are released first to allow for release of the first petal pair, followed by the release one or more petal release mechanisms holding a second-to-be-deployed petal pair. For example, in the embodiment of FIG. 1C, petal release mechanism holding petal pair 128-1 is released, followed by 128-2, and 128-3.

Release of the petal release mechanisms may be controlled by a controller or timing mechanism such that any prior deployed petal pair 128 is sufficiently deployed prior to the release of a subsequent petal pair 128.

While the reflector assembly 100 includes primary and secondary release mechanisms, other embodiments may include only spacecraft tie-down release mechanisms, only petal release mechanisms, or neither. Whether certain release mechanisms are used may be based on the environment or application of the reflector assembly 100, as well as the configuration of certain components.

Moving the petalled reflector 102 from the stowed configuration 170 of FIG. 1C to the deployed configuration 160 of FIG. 1A may include moving the petalled reflector from a launch/stowed configuration to a sufficient distance away from the spacecraft to which the boom 104 is connected, as shown in FIG. 1D. In order to accommodate the boom 104 (e.g., accommodate for stowage in a launch configuration, accommodate for the deployment function), the petalled reflector 102 may be configured to flip one or more times during deployment, as shown in FIG. 1D. The boom 104 may provide one or more additional axes or degrees of freedom for the petalled reflector 102 to flip the one or more times during deployment. Such flipping may be understood to mean flipping the reflector 102 (which may be partially deployed and termed a “reflector stack”) pointing the reflecting surface towards Earth. The boom 104 may interconnect or interface with the petalled reflector 102 at the perimeter or central portion thereof (e.g., at the perimeter or central portion of the central reflecting portion 106).

The boom 104 includes a first segment 105-1 and a second segment 105-2 (collectively referred to as the segments 105 and generically referred to as the arm segment 105). The boom further includes a joint 107 connecting the segments 105. When the boom 104 actuates the petalled reflector 102, the joint 107 actuates the second segment relative to the first segment. It will be appreciated by one of skill in the art that the boom 104 may include more or fewer segments 105 than are shown in FIGS. 1A and 1C and correspondingly more or fewer joints than the joint 107 as shown in FIGS. 1A and 1C.

The boom 104 further includes a principal actuator 109 for connecting the boom 104 to the spacecraft (not shown) and actuating the boom 104, specifically the first segment 105, relative to the spacecraft.

In an embodiment, the principal actuator 109 is similar to or identical to the joint 107.

In an embodiment, joints 109 and 107 may impart rotational and/or translational motions or any combination thereof.

It will be appreciated by one of skill in the art that, where segments 105 are relatively short, the boom 104 may include more segments 105 and correspondingly more joints 107 thereby to actuate the petalled reflector 102 away from the spacecraft. Where a spacecraft is relatively small, the boom 104 preferably includes more segments 105 and correspondingly more joints 107.

It will be appreciated by one of skill in the art that, where segments 105 are relatively long, the boom 104 may include fewer segments 105 and correspondingly fewer joints 107 thereby to actuate the petalled reflector 102 away from the spacecraft. Where a spacecraft is relatively large, the boom 104 preferably includes fewer segments 105 and correspondingly fewer joints 107.

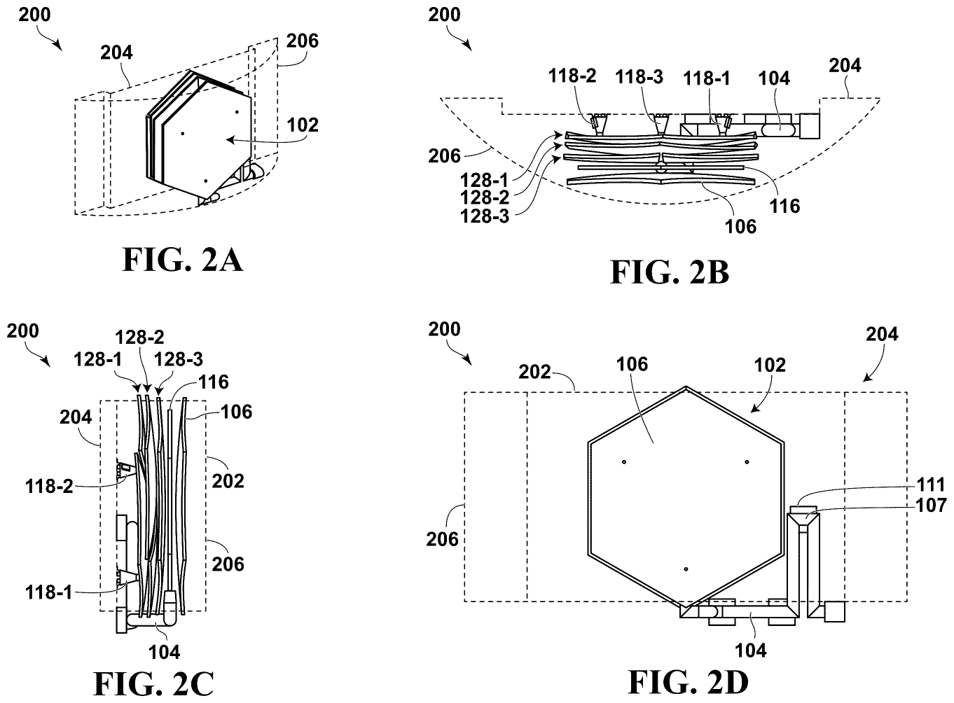

The boom 104 further includes boom tie-downs 111 (refer to FIG. 2D) for retaining the boom 104 in place when stowed in the spacecraft.

In a particular nonlimiting example, the petalled reflector assembly may measure approximately 3 meters to 5 meters in diameter when deployed.

Referring now to FIGS. 2A to 2D, shown therein is the reflector assembly 100 of FIGS. 1A-1D with the reflector 102 in the stowed configuration 170 within a reflector stowed stay-in envelope 200, according to an embodiment. The reflector stay-in envelope 200 may be a defined volume available to house the reflector assembly 100 when stowed (e.g., during launch).

The reflector stowed stay-in envelope 202 includes an inboard side 204 and an outboard side 206. The inboard side 204 may be relatively straight. The outboard side 206 may be relatively arcuate.

Although FIGS. 2A and 2D show the reflector 102 with the central reflecting portion 106 facing the outboard side 206, in other embodiments, the reflector 102 may be stowed in the reflector stowed stay-in envelope 202 with the central reflecting portion 106 facing the inboard side 204.

When the reflector 102 is stowed in the reflector stowed stay-in envelope 202 with the central reflecting portion 106 facing the inboard side 204, the reflector 102 may be turned or otherwise manipulated in more or different ways when moving from the deployed configuration 160 to the stowed configuration 170 or from the stowed configuration 170 to the deployed configuration 160 than if stowed with the central reflecting portion 106 facing the outboard side 206.

Stowing the reflector 102 with the central reflecting portion 106 out locates the smaller spacecraft tie-down holes 112 in the high-energy RF area of the central reflecting portion 106. Consequently, the larger holes 114 are located in the low-energy RF areas of the reflector petals 108. This embodiment provides the least disturbance to the RF pattern generated by the reflector RF shape.

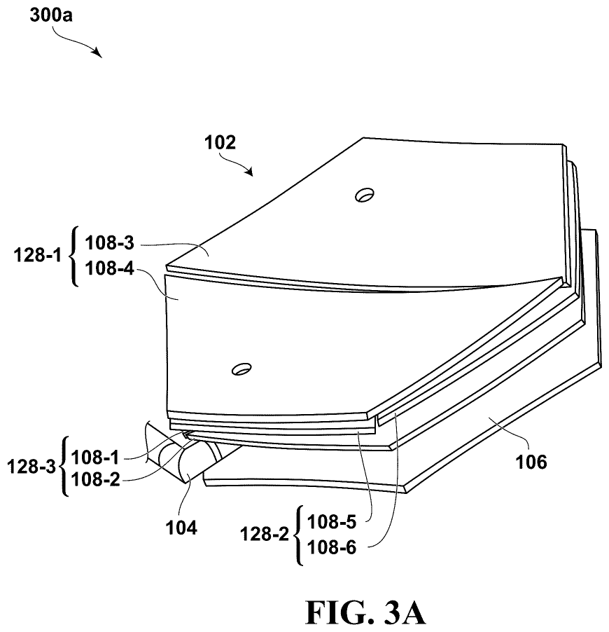

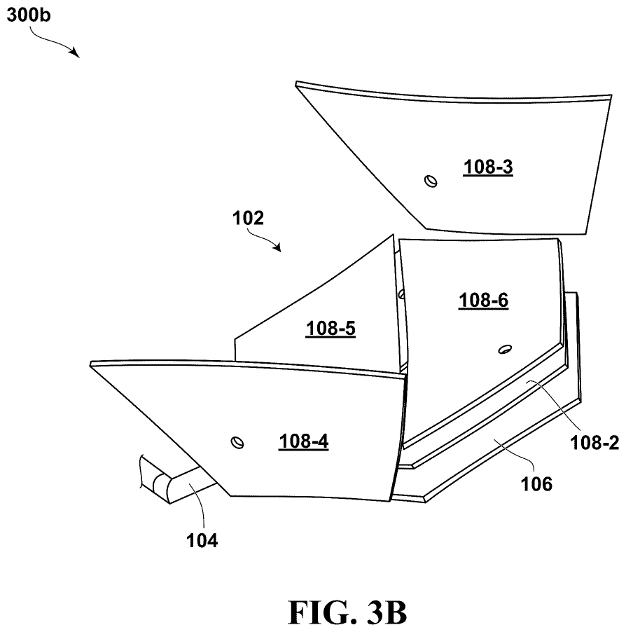

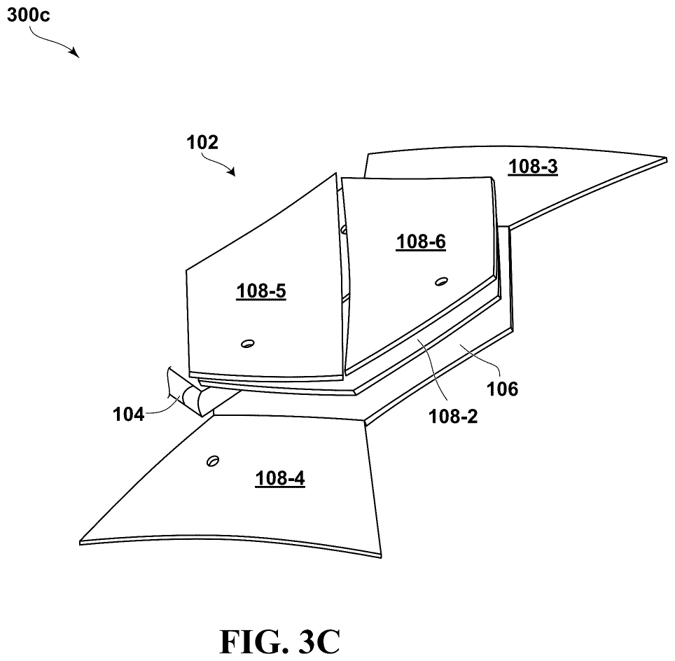

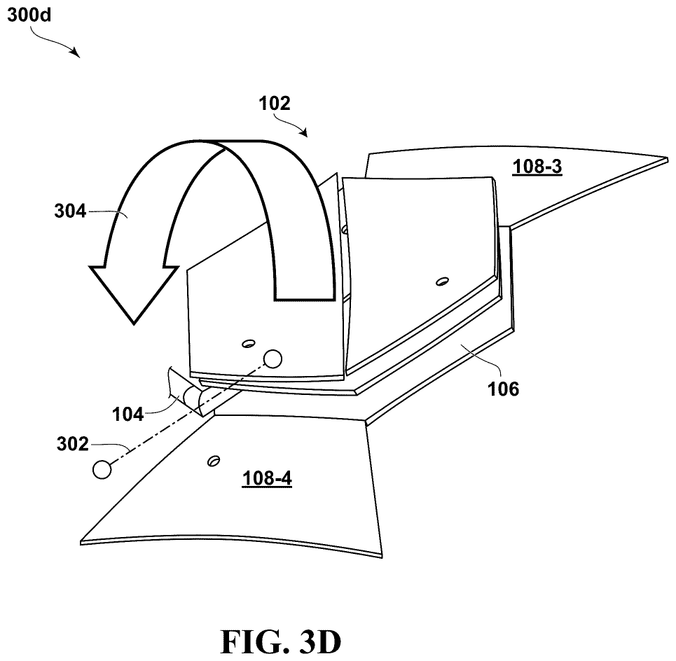

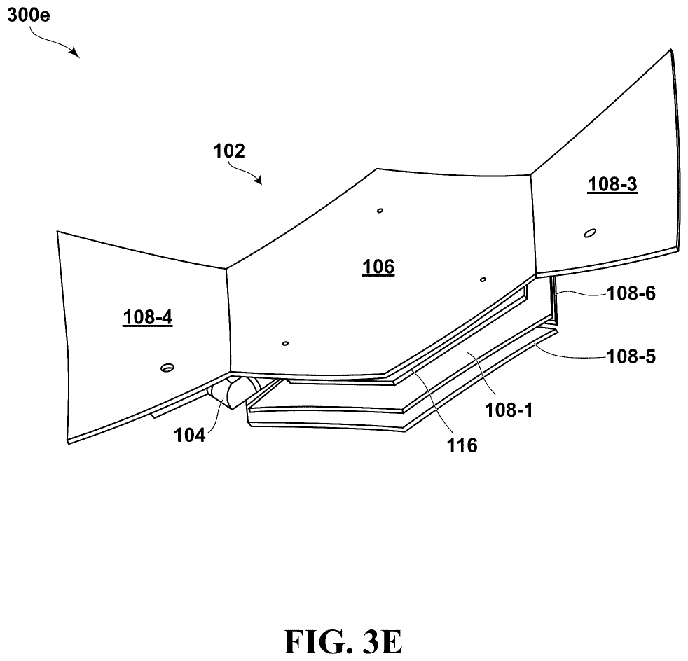

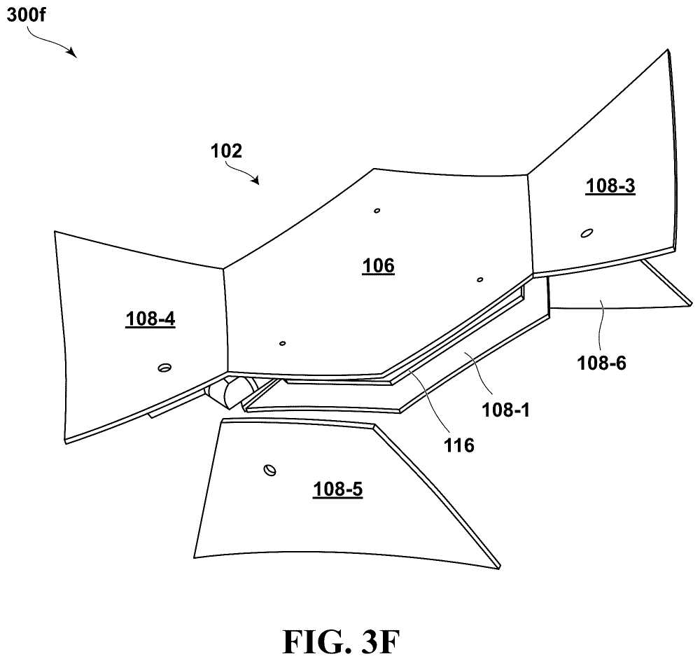

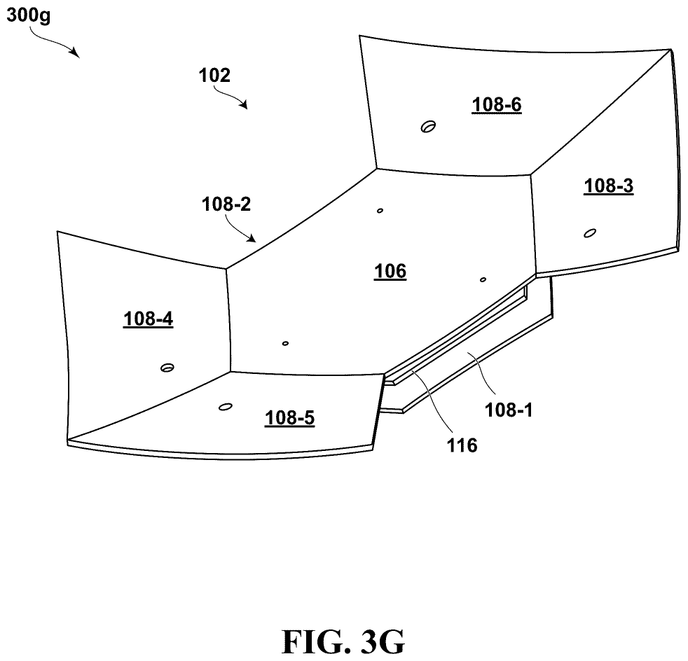

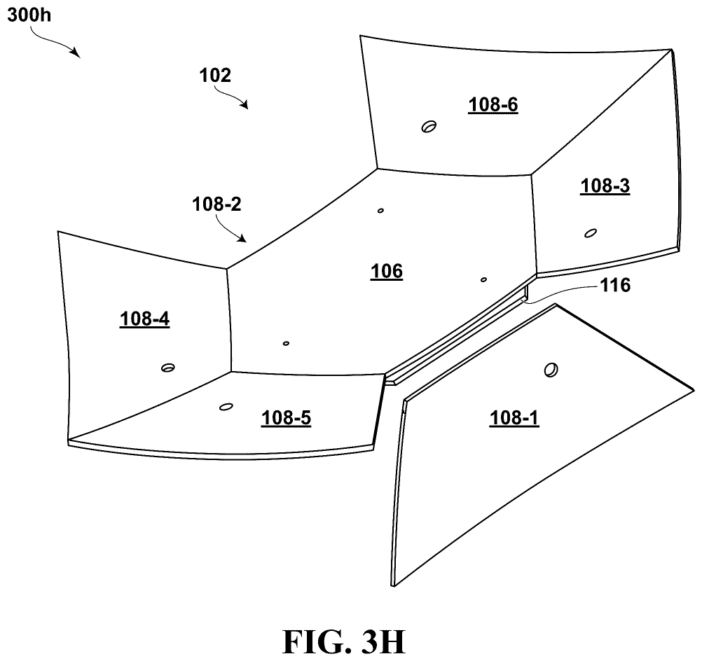

Referring now to FIGS. 3A to 31, shown therein are stages 300a-300i of a deployment sequence of the petalled reflector 102 of FIGS. 1A-1D from the stowed configuration 170 to the deployed configuration 160, according to an embodiment.

FIG. 3A shows a first stage 300a of the deployment sequence. The reflector 102 is in the fully stowed configuration. The reflector 102 includes petal pairs 128-1, 128-2, 128-3 stacked on the central reflecting portion 106. At stage 300a, any spacecraft tie-down release mechanisms have been released. The boom 104 has moved the stowed reflector 102 to a deployment position, which may be a predetermined distance away from the spacecraft and other obstacles to enable full deployment.

FIG. 3B shows a second stage 300b of the deployment sequence. The first petal pair 128-1 are deploying. Petal release mechanisms (not shown) fixing petals 108-3, 108-4 to each other have been released. Petals 108-3 and 108-4 start to fold about their respective folding edges via their respective folding mechanisms (e.g., spring loaded hinge).

FIG. 3C shows a third stage 300c of the deployment sequence. Petals 108-3, 108-4 are fully deployed. Second petal pair 128-2 including petals 108-5, 108-6 are now visible and ready to deploy.

FIG. 3D shows a fourth stage 300d of the deployment sequence. The reflector 102 is flipped via boom 104 about axis 302. Rotation of the reflector is denoted by arrow 304. If not flipped, the boom 104 may interfere with deployment of the remaining stowed petals 108.

FIG. 3E shows a fifth stage 300e of the deployment sequence. The reflector 102 has been flipped relative to stage 300d. In this flipped state, petals 108-5, 108-6 can deploy without interference with boom 104. Petal release mechanisms holding petals 108-5 and 108-6 together are released.

FIG. 3F shows a sixth stage 300f of the deployment sequence. Petals 108-5, 108-6 start to deploy along their respective folding edges via their respective folding mechanisms.

FIG. 3G shows a seventh stage 300g of the deployment sequence. Petals 108-5, 108-6 are fully deployed. Petal release mechanisms holding petals 108-1 and 108-2 (not visible) together may be released to enable deployment of the petals.

FIG. 3H shows an eighth stage 300h of the deployment sequence. The third petal pair 128-3 including petals 108-1 and 108-2 (not visible) start to deploy along their respective folding edges via their respective folding mechanisms.

FIG. 3I shows a ninth stage 300i of the deployment sequence. Petals 108-1, 108-2 are fully deployed. With all petals 108 fully deployed, the reflector 102 is fully deployed.

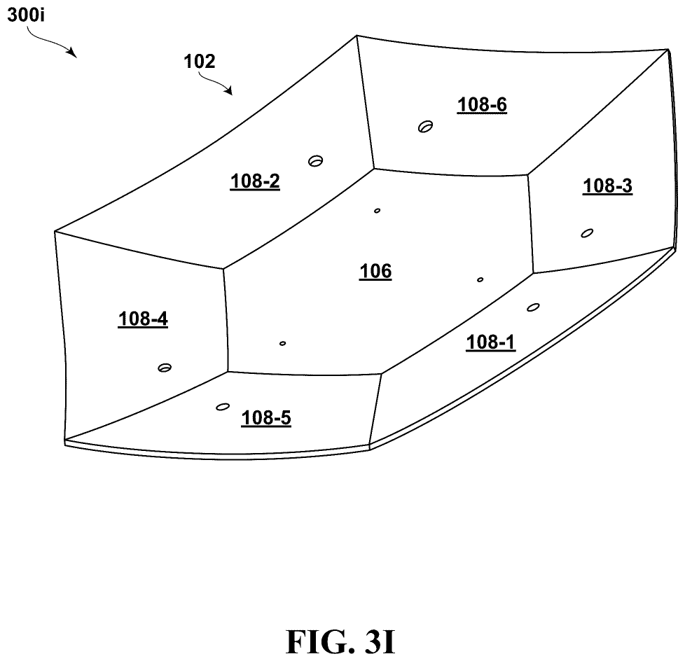

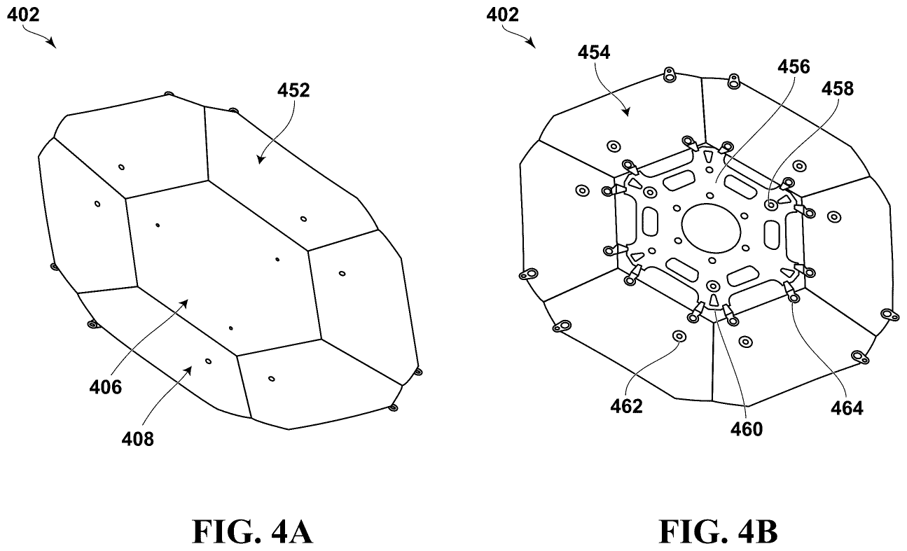

Referring now to FIGS. 4A-4B, shown therein is a petalled reflector 402, according to an embodiment. FIG. 4A shows a top perspective view of a radio frequency (“RF”) reflective surface 452 of the reflector 402. FIG. 4B shows a bottom perspective view of a mounting/back surface 454 of the reflector 402.

The reflector 402 includes a hexagonal central reflecting portion 406 and six petals 408 disposed around the hexagonal central reflecting portion 406. Hexagonal central reflecting portion 406 may be similar to central reflecting portion 106 and petal 408 similar to petals 108. Petal 408 are irregular hexagonal in shape, rather than trapezoidal as in reflector assembly 100.

The mounting surface 454 includes a support panel 456. The support panel 456 is common to each of the individual petals in the petal shell 408 and the central reflecting portion 406. The support panel 456 may be used as the support panel 116 of reflector assembly 100.

The support panel 456 includes three reflector tie-down interfaces 458 for receiving tie-downs (not shown) to attach the stowed reflector 402 to the spacecraft to which the reflector 402 is coupled. In an embodiment, the number of reflector tie-down interfaces 458 provided is six.

The support panel further includes a boom interface 460 for connecting a boom (e.g., boom 104) to the reflector 402.

The support panel 456 further includes six petal tie-down interfaces 462 for receiving the tie-downs. Each tie-down is received by two petal tie-down interfaces 462 and one reflector tie-down interface 458.

In an embodiment, where the reflector has a diameter less than or equal to 3 metres when deployed, 3 reflector tie-down interfaces 458 and 12 petal tie-down interfaces 462 may be used.

In an embodiment, where the reflector has a diameter between 3 and 5 metres when deployed, 6 reflector tie-down interfaces 458 and 24 petal tie-down interfaces 462 may be used.

The support panel 456 further includes twelve hinges 464 for controlling the release of the petal 408 from the stowed configuration 170 to the deployed configuration 160. The hinges 464 may be spring-loaded hinges with passive dampers. Two hinges 464 are dedicated to the deployment of one petal 408.

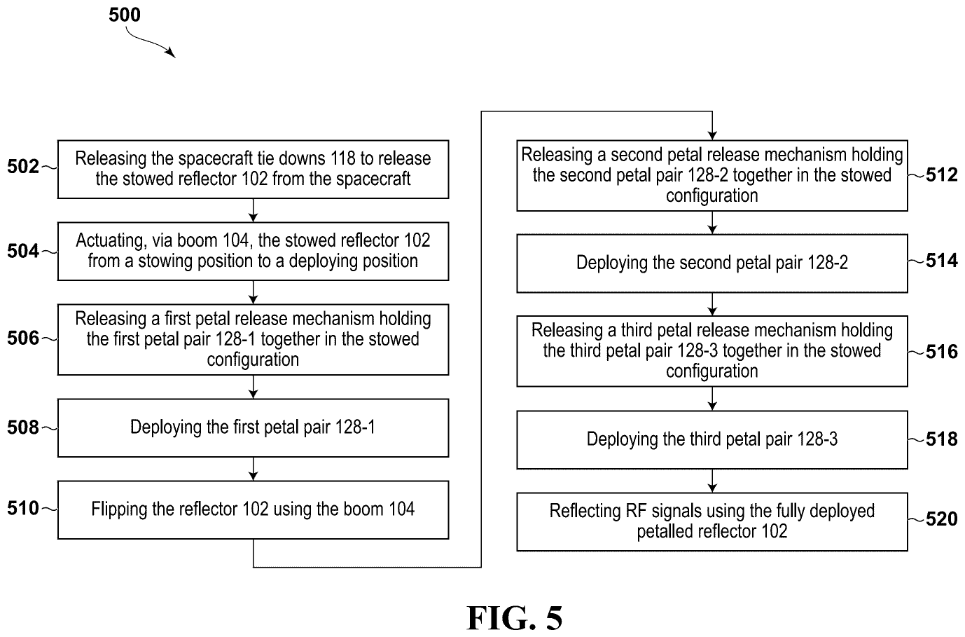

Referring now to FIG. 5, shown therein is a method 500 of deploying the petalled reflector 102 of FIGS. 1A-1D, according to an embodiment.

At 502, the method 500 includes releasing the spacecraft tie-down release mechanisms 118 to release the stowed reflector 102 from the spacecraft.

At 504, the method 500 includes actuating, via boom 104, the stowed reflector 102 from a stowing position to a deploying position. The deploying position may be a position that has sufficient clearance from the spacecraft and other obstacles for reflector deployment.

At 506, the method 500 includes releasing a first petal release mechanism holding the first petal pair 128-1 together in the stowed configuration.

At 508, the method 500 includes deploying the first petal pair 128-1.

At 510, the method 500 includes flipping the reflector 102 using the boom 104.

At 512, the method 500 includes releasing a second petal release mechanism holding the second petal pair 128-2 together in the stowed configuration.

At 514, the method 500 includes deploying the second petal pair 128-2.

At 516, the method 500 includes releasing a third petal release mechanism holding the third petal pair 128-3 together in the stowed configuration.

At 518, the method 500 includes deploying the third petal pair 128-3. The reflector 102 is now fully deployed.

At 520, the method 500 includes reflecting RF signals using the fully deployed reflector 102.

It will be appreciated by one of skill in the art that the foregoing method 500 may be applicable to a petalled reflector in which the central reflecting portion 106 of the petalled reflector 102 is inboard. When the central reflecting portion 106 is inboard, the boom 104 flips the petalled reflector 102 after the method 520 is performed. Thus, when the central reflecting portion 106 is inboard, the reflector 102 is flipped two times.

While the above description provides examples of one or more apparatus, methods, or systems, it will be appreciated that other apparatus, methods, or systems may be within the scope of the claims as interpreted by one of skill in the art.

1. An antenna reflector for reflecting a radio frequency (RF) signal, the antenna reflector having a smaller footprint when stowed than when deployed, the antenna reflector comprising:
a hexagonal central reflecting portion having a first face and an opposed second face, the first face for reflecting the RF signal, and six central edges of equal length; and
six trapezoidal petals disposed about the hexagonal central reflecting portion and having first faces and opposed second faces, the first faces for reflecting the RF signal, each two opposing petals forming a petal pair, each petal comprising:
a first edge equal in length to a respective central edge, wherein each first edge is disposed adjacent to the respective central edge;
a second edge greater in length than the first edge and parallel to the first edge;
third and fourth edges connecting the first and second edges;
wherein in a stowed configuration each petal pair is folded and has a cross-sectional footprint substantially identical to a cross-sectional footprint of the central reflecting portion, and each of the second edges of each petal pair are mutually adjacent;
wherein in a deployed configuration each petal is not folded, the petals and the central reflecting portion together form a hexagon with a cross-sectional footprint larger than the cross-sectional footprint of the central reflecting portion, each third edge of each petal is disposed adjacent a respective fourth edge of an adjacent petal, and each fourth edge of each petal is disposed adjacent a respective third edge of an adjacent petal;
wherein each petal is configured to fold along the first edge from the deployed configuration to the stowed configuration and each petal is configured to unfold along the first edge from the stowed configuration to the deployed configuration.

2. The antenna reflector of claim 1 further comprising a boom connected to the second face of the central reflecting portion for actuating the antenna reflector;
wherein the boom flips the antenna reflector at least once when the petals fold from the deployed configuration to the stowed configuration or when the petals unfold from the stowed configuration to the deployed configuration, to avoid interference with the boom.

3. The antenna reflector of claim 1, wherein the petals and the central reflecting portion are curved.

4. The antenna reflector of claim 1, wherein the petals and the central reflecting portion are flat.

5. The antenna reflector of claim 1 further comprising three primary release mechanisms, each primary release mechanism for releasably fastening at least some of the petals to the central reflecting portion.

6. The antenna reflector of claim 5 further comprising six folding mechanisms, each folding mechanism disposed about a respective first edge of a respective petal for selectively allowing or disallowing the respective petal to fold or unfold.

7. The antenna reflector of claim 6, wherein the primary release mechanisms are tie-downs and the folding mechanisms are hinges.

8. The antenna reflector of claim 1, wherein at least one petal pair is configured to fold towards the first face of the central reflecting portion and at least one other petal pair is configured to fold towards the second face of the central reflecting portion.

9. The antenna reflector of claim 1, wherein all petal pairs are configured to fold towards the same face of the central reflecting portion.

10. A method for deploying a petalled reflector for reflecting an RF signal, the petalled reflector for fitting into a smaller footprint when stowed than when deployed, the method comprising:
providing the petalled reflector in a stowed configuration, the petalled reflector comprising a hexagonal central reflecting portion having a first face and an opposed second face, the first face for reflecting the RF signal, and six central edges of equal length, and six trapezoidal petals disposed about the hexagonal central reflecting portion and having first faces and opposed second faces, the first faces for reflecting the RF signal, each two opposing petals forming a petal pair, each petal comprising a first edge equal in length to a respective central edge, wherein each first edge is disposed adjacent a respective central edge, a second edge greater in length than the first edge and parallel to the first edge, and third and fourth edges connecting the first and second edges;
wherein in the stowed configuration each petal pair is folded and has a cross-sectional footprint substantially identical to a cross-sectional footprint of the central reflecting portion, and each of the second edges of each petal pair are mutually adjacent;
unfolding each pair of petals along the first edge;
disposing each third edge of each petal adjacent a respective fourth edge of an adjacent petal and disposing each fourth edge of each petal adjacent a respective third edge of an adjacent petal; and
wherein the petals and the central reflecting portion together form a hexagon with a cross-sectional footprint larger than the cross-sectional footprint of the central reflecting portion.

11. The method of claim 10 further comprising:
actuating the petalled reflector with a boom connected to the second face of the central reflecting portion; and
flipping the petalled reflector at least once to avoid interference with the boom.

12. The method of claim 10, wherein the petals and the central reflecting portion are flat.

13. The method of claim 10 further comprising releasably fastening at least some of the petals to the central reflecting portion with each of three primary release mechanisms.

14. The method of claim 13 further comprising selectively allowing or disallowing a respective petal to unfold using each of six folding mechanisms, each folding mechanism disposed about the respective first edge.

15. The method of claim 14, wherein the primary release mechanisms are tie-downs and the folding mechanisms are hinges.

16. A method for stowing a petalled reflector for reflecting an RF signal, the petalled reflector for fitting into a smaller footprint when stowed than when deployed, the method comprising:
providing the petalled reflector in a deployed configuration:
wherein the petalled reflector comprises:
a hexagonal central reflecting portion having a first face and an opposed second face, the first face for reflecting the RF signal, and six central edges of equal length; and
six trapezoidal petals disposed about the hexagonal central reflecting portion and having first faces and opposed second faces, the first faces for reflecting the RF signal, each two opposing petals forming a petal pair, each petal comprising a first edge equal in length to a respective central edge,
wherein each first edge is disposed adjacent a respective central edge, a second edge greater in length than the first edge and parallel to the first edge, and third and fourth edges connecting the first and second edges;
wherein in the deployed configuration each third edge of each petal is disposed adjacent a respective fourth edge of an adjacent petal and each fourth edge of each petal is disposed adjacent a respective third edge of an adjacent petal, and wherein the petals and the central reflecting portion together form a hexagon with a cross-sectional footprint larger than that of the central reflecting portion;
folding each pair of petals along the first edge; and
wherein each petal pair when folded has a cross-sectional footprint substantially identical to a cross-sectional footprint of the central reflecting portion, and wherein each of the second edges of each petal pair are mutually adjacent when folded.

17. The method of claim 16, wherein the petals and the central reflecting portion are curved.

18. The method of claim 16 further comprising selectively allowing or disallowing a respective petal to fold using each of six folding mechanisms, each folding mechanism disposed about the respective first edge.

19. The method of claim 16 further comprising folding at least one petal pair towards the first face of the central reflecting portion and folding at least one other petal pair towards the second face of the central reflecting portion.

20. The method of claim 16 further comprising folding all petal pairs towards the same face of the central reflecting portion.
